(19) United States
(12) Patent Application Publication
(10) Pub. No.: US 2012/0287179 A1
(43) Pub. Date: Nov. 15, 2012

(54) Method for Writing an Image in a Liquid Crystal Display

(75) Inventor: Umberto Rossini, Coublevie (FR)

(73) Assignee: Commissariat a l'Energie Atomique et aux Energies Alternatives, Paris (FR)

(21) Appl. No.: 13/522,691

(22) PCT Filed: Jan. 21, 2011
(86) PCT No.: PCT/EP2011/050814

§ 371 Date: Jul. 17, 2012

(30) Foreign Application Priority Data
Feb. 2, 2010 (FR) 1000403
Mar. 30, 2010 (FR) 1001292

(51) Int. Cl. G09G 3/36

(52) U.S. Cl. 345/690; 345/89

(57) ABSTRACT

A method of display on a color sequential liquid crystal screen, notably an LCOS technology screen (integrated circuit screen), is provided. The liquid crystal between a pixel electrode and counter-electrode common to all pixels, and provision is made to alternate the potential of the counter-electrode at each frame. Writing an image comprises successive addressing of various rows and simultaneous application of a voltage level to column conductors. The writing phase is followed, before the end of a frame, by a phase of switching counter-electrode potential wherein the transistors of the various rows are successively turned on for durations which overlap mutually such that all transistors are simultaneously on at a given moment of this switching phase, and the potential of the counter-electrode is switched at this moment. Overvoltages are thus avoided on the control transistors at the level of the pixel at the moment of the switching of counter-electrode potential.

The invention relates to the display of images in color sequential mode by an active-matrix liquid-crystal display. It applies more particularly to screens of small dimensions, embodied for example on silicon substrates (LCOS technology from the English “Liquid Crystal on Silicon”).

An active-matrix display comprises a matrix of rows and columns of pixels, each pixel comprising a liquid crystal between a pixel electrode and a counter-electrode common to all the pixels. The voltage applied between the pixel electrode and the common electrode produces an electric field which orients the molecules of the liquid crystal as a function of the modulus of the field. This orientation acts on the polarization of the light which passes through the crystal so as to define, in combination with the use of polarizers, a light transmission level which depends on the electric field applied. A control transistor (the active element of the pixel) links the pixel electrode of all the pixels of one and the same column to a respective column conductor. The column conductor receives at a given moment an analog voltage defining a gray level to be applied to the pixel; if the transistor is conducting, this voltage is applied to the pixel electrode; otherwise, the pixel behaves as an isolated capacitor and preserves the voltage level previously received. The control transistors of one and the same row of pixels are controlled by a respective row conductor; thus, during the writing of an image frame, the various rows of the matrix are addressed successively so as to write at a given instant into the pixels of the addressed row the information applied at this instant by the column conductors.

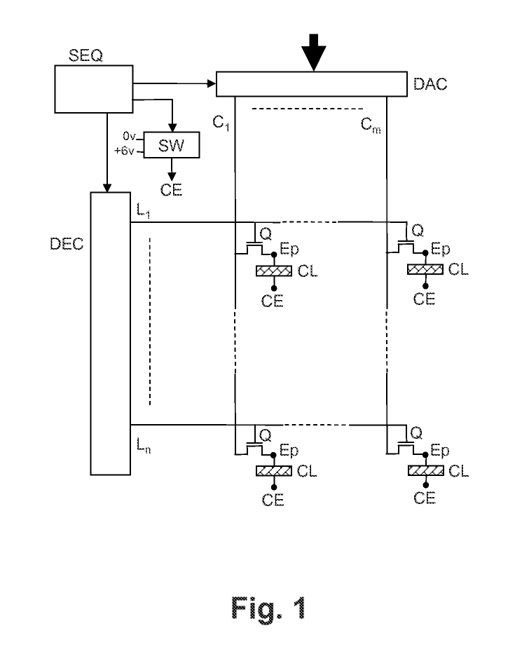

FIG. 1 represents the general structure of such a matrix, where CL denotes a liquid-crystal cell and Q denotes the transistor associated with this cell, the assembly of the cell and transistor together forming the pixel. The common counter-electrode of the cell is denoted CE, the electrode of the pixel is denoted Ep. The row-wise control conductors are denoted L₁ to Lₙ for a matrix of n rows. The column conductors are C₁ to Cₘ for a matrix of m columns. A row decoder DEC successively addresses the various rows. During the addressing of a row, a set of analog voltages representing the image to be displayed by this row is applied to the column conductors by a digital-analog conversion circuit DAC. The conversion circuit establishes these analog voltages on the basis of a digital signal. A sequencing circuit SEQ ensures synchronized operation of the row decoder and of the conversion circuit DAC.

For reasons related to the nature of the liquid crystal, it is desirable that the mean electric field applied to the liquid-crystal cells be zero; if this were not the case the liquid crystal would polarize progressively as a function of this field, and this would end up being seen on the display in the form of defects (termed defects of marking of the screen). To avoid this polarization, it is possible to alternate the direction of this field at each frame (or at each column, or at each row, or at each pixel); it is possible to do so since the direction of the field does not influence the gray level, only its amplitude defines the gray level. In the case of screens of small dimensions with small pixels (with sides of from a few micrometers to 20 micrometers), it is preferable to use a frame inversion, that is to say an alternation of directions of field at each frame, since the transverse fields between pixels disturb a non-negligible fraction of the surface of the pixel. Frame-wise alternation partly safeguards the pixels by preventing the appearance of significant transverse fields.

The alternation of directions of the field in this frame inversion mode can be done in two different ways:
either by retaining a fixed voltage, for example 0 volts, on the counter-electrode CE and by alternating the polarity of the signal provided by the conversion circuit DAC to the pixel electrodes Ep: during the even frames, the polarity is positive on the electrodes Ep, for example between 0 volts and +6 volts; during the odd frames, the polarity is negative, for example between 0 volts and −6 volts;
or by preserving a single polarity for the electrodes Ep, for example between 0 volts and +6 volts, and by alternating the voltage applied to the counter-electrode, between a low value (for example Vmin=0 volts) during the odd frames and a high value (for example Vmax=+6 volts) during the even frames; this signifies that a given digital value representing a gray level must be converted into two different analog voltages depending on whether an even frame or an odd frame is involved. For example if the image is black for a zero electric field, the analog signal to produce a black pixel must be 0 volts during an odd frame but it must be 6 volts during an even frame. The conversion circuit must be suitable for effecting this periodic change.

The drawback of the first process is the requirement to have analog circuits (and notably the conversion circuit DAC) that are capable of working between positive and negative power supply levels. Technologically this renders the circuits more complex; this is not the case for the second process.

The second process consisting in switching from frame to frame the potential applied to the counter-electrode, between a low value and a high value, is therefore preferred.

The switching must be done during the interval of time between two successive frames: it cannot be done while writing the rows. But when there is no writing of rows, the control transistors which link the pixel electrodes to the column conductors are all turned off. The abrupt switching of the counter-electrode causes, by capacitive transmission, a voltage variation of the same amplitude and of the same sign on the drain of the transistor and, during the following frame, the transistor will have between the drain and the source a voltage double that which it ought to have in view of the analog signal representing the information to be displayed. For example, it is possible to have the following situation: the counter-electrode CE is at a low potential (0 volts), a zero potential is present on the column conductor (linked to the drain of the transistor) just before the switching, and a potential of +6 volts is present on the pixel electrode (linked to the source of the transistor); during the abrupt switching of the counter-electrode from 0 volts to +6 volts, the potential of the electrode of the pixel and the drain of the turned-off transistor rise steeply by capacitive transmission to +12 volts, the source remaining at 0 volts.

For displays of small dimension embodied according to integrated-circuit technologies (displays or optical modulators using LCOS technology) a voltage of 12 volts is too high and risks damaging the transistor.

This is why it is proposed according to the invention to use the row decoder at the end of the frame to control successively row by row the turning on of the transistors of all the rows of the matrix for durations which overlap mutually in such a way that all the transistors of all the rows are simultaneously on at a given moment; the potential of the counter-electrode is switched at this moment.

More precisely, the invention proposes a method for writing an image in a liquid-crystal display, the display comprising a matrix of rows and columns of pixels, each pixel comprising a liquid crystal between a pixel electrode and a counter-electrode common to all the pixels, with a control transistor linking the pixel electrode to a respective column conductor common to all the pixels of one and the same column, the column conductor receiving an analog signal defining a gray level applied to the pixel, the control transistors of the pixels of one and the same row being controlled by a respective row conductor, in which method the writing of an image comprises the successive addressing of the various rows and the simultaneous application of a signal level to the column conductors, and in which the potential applied to the counter-electrode is alternated between a low value during the odd frames and a high value during the even frames, characterized in that the writing phase is followed, before the end of a frame, by a phase of switching counter-electrode potential in which the transistors of the various rows are successively turned on row by row for durations which overlap mutually in such a way that all the transistors of all the rows are simultaneously on at a given moment of this switching phase, and the potential of the counter-electrode is switched at this moment.

The duration of turning on of the transistors is preferably the same for all the rows, and longer than the time which separates the start of the turning on of the transistors of the first row and the start of the turning on of the transistors of the last row.

In practice, the sequencing of the successive addressing of the various rows during the switching phase is much faster than the sequencing during the phase of writing the matrix (or image generating phase). The sequencing consists in regularly staggering between a start instant t0 and a final instant t1 the start of addressing of the various rows. If the duration Tc of turning on of the transistors is identical for all the rows of transistors, then Tc is chosen to be strictly greater than the value t1−t0. Thus, during an interval of time lying between t1 and t0+Tc all the transistors are on. The phase of switching the counter-electrode potential is executed during this time interval.

The duration from t0 to t1 is chosen to be as fast as possible in view of the capabilities of the row decoder. The duration Tc is chosen to be sufficient such that the time interval between t1 and t0+Tc makes it possible for the switching of the counter-electrode to be performed completely, and for useful information, for example a determined voltage rather than an electric charge, to be transmitted completely to the pixels.

A voltage level corresponding to the black level is preferably applied to the column conductors during the switching phase from the time t0 onwards, and this level is switched at the moment of the switching of the counter-electrode potential so as to remain a black level until the phase of writing the image for the following frame, i.e. at least until t1+Tc.

The invention is applied preferably to normally white displays whose transparency is a maximum for a zero voltage between pixel electrode and counter-electrode.

The prior art (WO2007/065903) has already proposed that the matrix be supplemented with a set of row-wise transistors (n transistors) and a set of column-wise transistors (m transistors) so as on the one hand to simultaneously turn on all the control transistors of the matrix and on the other hand to apply a precharge voltage alternating from frame to frame to the column-wise conductors (therefore to the pixel electrodes). But the counter-electrode is not switched, and the transistors of the successive rows are not turned on successively; moreover, the row decoder is not used to execute an addressing with overlap, and n+m transistors must be added around the matrix; this display is intended for wide display panels and not for an LCOS integrated circuit embodiment.

According to a significant aspect of the invention, in the case of a liquid-crystal display integrated on a semiconductor substrate and operating on the principle of the periodic switching of the voltage applied to the counter-electrode while the individual pixel electrodes all receive a voltage corresponding to a black level, switched at the same time as the switching of counter-electrode voltage, provision is made for the switched counter-electrode voltages to be produced by a voltage source outside the substrate and independent of the supply voltage Vcc of the integrated circuits formed on the semiconductor substrate, the discrepancy between the two counter-electrode voltages being greater than the value Vcc of the supply voltage of the integrated circuits. Synchronization of the switching of the outside voltage source is ensured by the integrated circuits of the substrate. This arrangement makes it possible to limit (for example to 3 volts) the voltage applied to the integrated circuits while applying a variation of counter-electrode voltage of greater than 3 volts, necessary to obtain a “white” and a “black” of sufficient qualities.

If the supply voltage of the integrated circuit is Vcc (the semiconductor substrate being considered to be at a reference potential of zero volts), the voltage source outside the substrate will be able to provide a voltage of less than 0 and a voltage of greater than Vcc.

For a normally white display (white for a zero voltage between electrode and counter-electrode) it is considered that there is a minimum threshold voltage Vth between electrodes below which the display remains white. It is preferably chosen to switch the counter-electrode voltage between a voltage Vmin approximately equal to −Vth and a voltage Vmax=Vcc+Vth, knowing that the black will then be obtained with a voltage at most equal to Vcc+Vth. If this voltage is not entirely sufficient to obtain good contrast, a contrast compensation film will be used.

Preferably, during the phase of switching at the end of a frame, an overvoltage (in a direction tending to enhance the black level) will be applied to the counter-electrode voltage just before switching its value with a view to the following frame and, at the moment of switching, an overvoltage will also be applied to it in a direction tending to enhance the black level, before bringing it back to the setpoint value Vmin or Vmax that it must have in the course of the following frame.

Finally, provision may be made for the writing of a frame to comprise a first writing of all the rows at the start of a frame and then at least one refresh writing in the course of the frame.

Other characteristics and advantages of the invention will become apparent on reading the detailed description which follows and which is given with reference to the appended drawings in which:

FIG. 1 represents the structure of a liquid-crystal matrix display for the implementation of the invention;

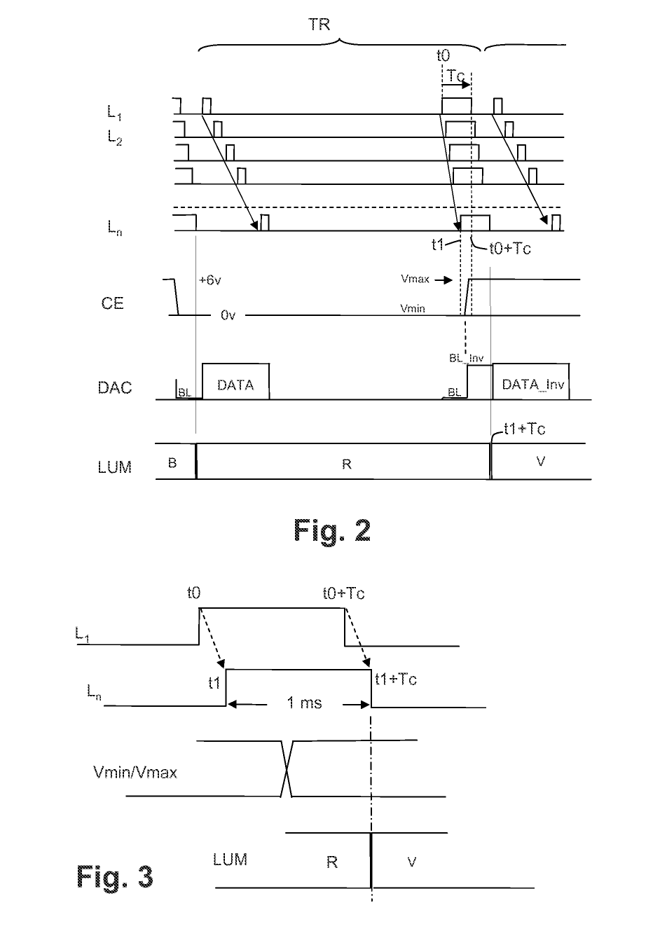

FIG. 2 represents a timechart explaining the image writing method according to the invention;

FIG. 3 represents a detail of the timechart of FIG. 2;

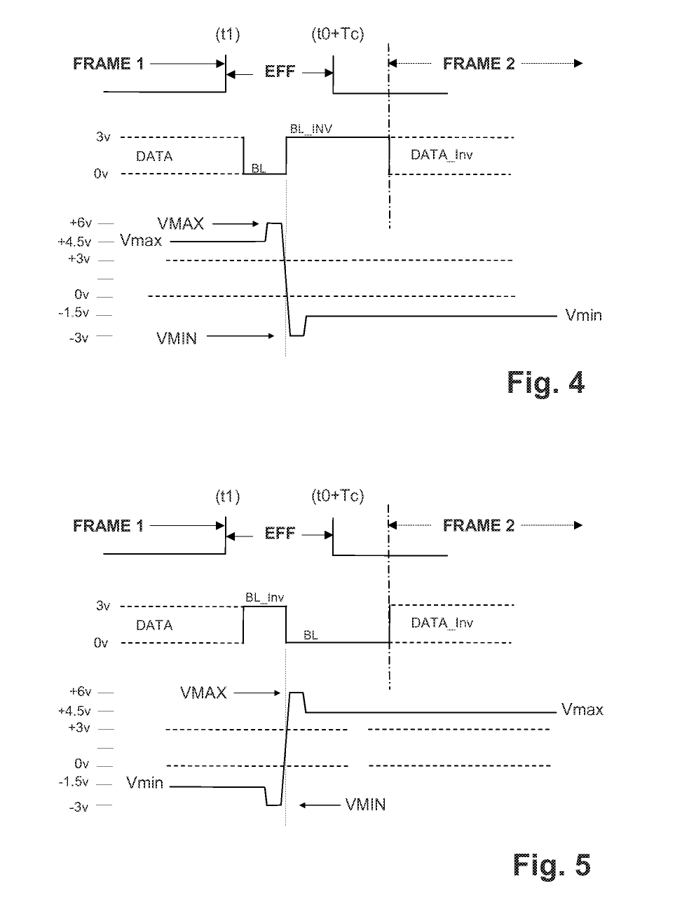

FIG. 4 represents a timechart of counter-electrode switching from Vmax to Vmin in the case where the voltage difference Vmax−Vmin is greater than the supply voltage Vcc of the integrated circuit;

FIG. 5 represents a similar timechart, for the following frame where the counter-electrode is switched from Vmin to Vmax.

The display may be of the type with colored filters, a color being assigned to each pixel, or be of the color sequential type without colored filters, colored light sources being controlled in synchronism with the control of the matrix so as to illuminate the latter with a different color at each image frame. The invention is most particularly applicable to displays of color sequential type and it will be considered hereinafter that the display is of this type. In what follows, the term “frame” will be used to define the writing of a complete image of a color on the screen; two successive frames correspond to two different colors in color sequential mode.

The liquid-crystal cell CL comprises a pixel electrode Ep specific to each pixel and a counter-electrode CE which is common to all the pixels. As was explained above, for reasons of preventing the marking of the screen, the potential of the counter-electrode will be switched at each frame in such a way that the electric field applied to the pixels reverses direction at each frame; the gray level of the pixel is determined by the greater or lesser transparency of the cell for a given light polarization; this transparency does not depend on the direction of the electric field but only on its amplitude.

For a cell CL situated at the crossover of a row and of a column of pixels, the control transistor Q of the cell is linked between the pixel electrode and a column conductor associated with all the pixels of the column. The gate of the control transistor is linked to a row conductor associated with all the pixels of the row. There are n row conductors L₁ to Lₙ and m column conductors C₁ to Cₘ.

The digital analog conversion circuit DAC receives the image information to be displayed; a frame comprises n rows and the image is written row by row; for a determined row, the circuit DAC receives m groups of digital values representing the gray levels to be written to the pixels of this row; it establishes on its outputs, linked to the column conductors, m levels of analog voltage representing the m gray levels; the row decoder selects the row conductor corresponding to the row that one wishes to write; this selection turns on all the control transistors Q of the pixels of the row but not those of the other rows; the cells CL of this row then receive on their pixel electrode Ep the respective analog voltages arising from the circuit DAC; the counter-electrode CE is at a constant potential throughout the frame; next, the decoder deselects the first row and selects another, while the conversion circuit DAC establishes another group of analog voltages corresponding to the new row to be written, and so on and so forth; a sequencing circuit SEQ synchronizes the operation of the row decoder DEC with the operation of the conversion circuit. The rows are preferably selected in regular succession in the order of their positions in the matrix; they could be selected in a different order provided that the image information applied to the column conductors does indeed correspond to what should be displayed in the selected row. At the end of a frame, the n rows of liquid-crystal cells have received a respective analog voltage corresponding to the gray levels that they must display. On account of their capacitive nature, during the remainder of the frame the cells preserve the charge applied at the moment of the turning on of their control transistor (the voltage applied does not remain constant on account of the reorientation of the liquid crystal the dielectric constant of which is anisotropic).

During the following frame, the row by row addressing of the matrix is begun again so as to register new gray levels therein.

Moreover, the potential level of the counter-electrode CE is switched at each frame, by giving it alternately a low level Vmin, for example 0 volts, during a frame of odd rank, and a high level Vmax, for example +6 volts, during a frame of even rank. This makes it necessary to modify the value of the analog voltage applied to the electrode Ep so that it is referenced with respect to the potential of the counter-electrode both during the odd frames and during the even frames. Thus, if a gray level is defined by the application of a voltage of absolute value Vx between the electrodes Ep and CE, then the analog voltage applied to the pixel electrode Ep must be Vx-Vmin during the odd frames and Vmax-Vx during the even frames. If precisely the voltage levels corresponding to a blackest pixel and a whitest pixel are chosen for Vmin and Vmax, the conversion circuit DAC will simply have to convert to analog the digital input signal during the odd frames and the inverse of the digital signal during the even frames, this being very easy to achieve.

The means, denoted SW in FIG. 1, for switching the potential of the counter-electrode are controlled by the sequencer in synchronism with the control of the row decoder DEC and the control of the conversion circuit DAC. The switching of the counter-electrode potential must be done outside of the phase of writing the rows such as indicated above, that is to say outside of the moment when the circuit DAC applies gray levels corresponding to a determined row of cells to this row. But if this switching is performed without precaution just after the writing of the last row of a frame and just before the writing of a new frame, it is appreciated as was stated above that there is a risk of causing source-drain overvoltages on the control transistors of the cells. These overvoltages are deleterious.

The writing sequence performed in the matrix under the command of the sequencing circuit so as to make it possible to switch counter-electrode potential CE with no risk of overvoltage on the control transistors Q will now be described with reference to FIG. 2.

The turn-on signal applied by the row decoder to the various rows during a complete image writing frame TR has been represented. Each frame is decomposed into a first phase which is a phase of writing gray levels into the rows and a second phase which is a specific phase of switching counter-electrode potential. According to the invention, during this specific phase, the row decoder is made to operate again but differently from the manner of operation adopted during the writing phase.

At the start of a frame, for the writing of the image proper, each row conductor L₁ to Lₙ receives a pulse which turns on the control transistors of this row. The pulses last for the time required for the control transistors Q to be able to charge the capacitor constituted by the pixel and optionally the storage capacitors (or compensation capacitors) of the circuit. The pulses follow one another for the writing of the various rows L₁ to Lₙ and do not overlap so that the transistors of a single row are simultaneously on.

The digital data DATA corresponding to the successive rows are converted and applied to the column conductors in synchronism with the selecting of the corresponding rows.

Towards the end of the frame, from an instant t0 subsequent to the writing of the last row of the matrix (row Lₙ if the rows are addressed successively, beginning with row L₁), the second phase is executed. In the second phase, the row decoder executes a new operation of successive addressing of the n rows, but this time the succession of the selections from one row to the next is faster (typically between 0.1 and 0.5 milliseconds to scan all the rows L₁ to Lₙ) since there is no need to wait for precise analog voltages, representing gray levels, to be established on the column conductors. Moreover, the selection of the rows is done with mutual overlap of the rows, that is to say the transistors of several rows may be simultaneously on. Finally, not only is there overlap between several rows but the duration of selection of the various rows is such that for a nonzero duration all the rows are addressed at the same time and therefore all the transistors of the matrix are simultaneously on. Preferably, for the sake of simplicity of embodiment and operation of the row decoder, the duration of turning on is the same for all the rows. The duration Tc must be long enough (typically of the order of a millisecond) to place all the pixels in the same state of charge. This will allow the pixel to be insensitive to the display history of the pixel and therefore to dispense with the look-up tables (LUK tables) conventionally used to define the signal to be applied to the pixel as a function of that applied during the previous frame. Advantageously, as will be seen, all the pixels will be placed in a state of charge corresponding to zero transmission of light (black pixel).

Thus, preferably, if the addressing of the rows begins at the instant t0 for the first row and begins at the instant t1 for the last row, the common duration Tc of turning on of the transistors of a row is greater than the interval t1−t0. A nonzero interval of time persists between the instant t1 and the instant t0+Tc. During this time interval all the transistors of the matrix are on. The switching of the counter-electrode potential from the potential Vmin to the potential Vmax or vice versa is triggered during this time interval.

At the same time, the conversion circuit DAC establishes a determined potential on the column conductors, that is to say it does not leave the column conductors at high impedance.

Hence, there is no risk of overvoltage across the terminals of the transistors or of other elements of the circuit on account of the switching of the counter-electrode potential.

Preferably, the conversion circuit, controlled by the sequencing circuit, produces during this switching phase a voltage which corresponds to a black level. But as the voltage to be applied to produce a black level depends on the counter-electrode potential and since the switching of this potential is actually in progress, provision is preferably made for the analog voltage present on all the column conductors to be switched from a voltage Vmin to a voltage Vmax or vice versa (depending on whether going from an odd frame to an even frame or vice versa) at the same time as the potential of the counter-electrode is switched.

FIG. 2 shows the voltage switching on the counter-electrode CE during the time interval from t1 to t0+Tc. The digital data to be converted into analog voltage are also represented. They are inverted from an odd frame to an even frame, so that if data DATA correspond to a given image during an odd frame, inverse digital data DATA_Inv must be applied during the following even frame in order to obtain the same image. The term DATA_Inv does not signify of course that data inverse to those of the previous frame are applied, but that data are applied which are referenced in the inverse sense to the data of the previous frame. For example, the frames follow one another in the order of the colors red, green, blue, and the data applied are data1R, data1G_Inv, data1B, data2R_Inv, data2G, data2B_Inv, etc.

But, before applying the new data DATA_Inv to the frame which follows, the conversion circuit applies to the column conductors, from the instant t0 onwards, an analog voltage level which corresponds to the black level BL. And as the black level inverts at the moment of the switching of the counter-electrode, the conversion circuit is controlled so as to invert the black level voltage applied at the moment when the counter-electrode voltage is switched.

So-called “normally black” liquid crystal screens have black pixels (minimum transparency) when a zero voltage is applied between Ep and CE. A black level is therefore obtained if the voltage applied to a column conductor is Vmin during the odd frames when the counter-electrode voltage is Vmin and it is conversely Vmax during the even frames when the counter-electrode voltage is Vmax. It would be the converse for so-called “normally white” screens which have a maximum transparency in the absence of voltage between Ep and CE. It is recalled that the screen is normally black or normally white as a function of the type of liquid crystal and of the mutual orientation of the polarizers which flank the cells: TN (twisted nematic) or MTN (mixed TN) liquid crystals are normally black if the polarizers are parallel, normally white if the polarizers are crossed; so-called “vertically aligned” liquid crystals are normally black in crossed polarizers, normally white in parallel polarizers. It is considered for the moment in FIG. 2 that the screen is normally black regardless of its structure, and that the frame TR represented is an odd frame where the counter-electrode voltage is Vmin, which means that the black level is defined by a voltage Vmin on the pixel electrode.

Consequently, at the start of the counter-electrode switching phase, the conversion circuit applies a voltage Vmin (black level BL) to all the column conductors; at the moment of the switching of counter-electrode potential, it applies a voltage Vmax (inverted black level BL_Inv) to all the column conductors; and finally, after the instant t0+Tc, and as a function of the successive pulses applied to the row conductors L₁ to Lₙ, it applies inverted image data DATA_Inv to the column conductors for the writing of the next frame which is an even frame.

From these arrangements it follows that during the phase of switching counter-electrode potential, there is no risk of feeding gray level information to the pixels, which could be in contradiction with the image that was displayed during the frame. Only black information is added temporarily.

It will be noted that the black level BL (Vmin if TR is an odd frame or Vmax if it is an even frame) may be applied to the columns not only beginning just before the instant t0 as is represented in FIG. 2 but also throughout the preceding time interval, after the end of the writing of the n rows of the frame. This black level is present on the columns but is not transferred to the cells before the instant t0.

By observing the timechart of FIG. 2, it is seen that the duration for which a pixel preserves an item of gray level information depends on the rank of the row. This follows from the fact that the addressing of the succession of n rows is faster at the end of the frame (preparation of the counter-electrode switching) than at the start of the frame (writing of the gray levels). It would be possible to choose to preserve the same scan speed for the rows at the start and at the end of the frame, but this would reduce the overall luminance of the screen. It is possible to compensate for this phenomenon by systematically modifying the signal level as a function of the rank of the row so as to take account of the difference in illumination time of the various rows. It is also possible to decide to alternate the direction of scanning of the rows, from L1 to Ln for one frame, and from Ln to L1 for a following frame of the same color, thereby on average canceling the discrepancy in duration of illumination of the various rows.

In the foregoing, it was considered that the application of a gray level in the form of an analog voltage to a column conductor consisted in placing a constant voltage on this conductor during the addressing time for the corresponding row. However, the invention is applicable also in the cases where the voltage application is done in a more sophisticated manner, notably when positive or negative temporary supercharge voltages are applied to the column conductors, that is to say voltages that are higher or lower than the voltage actually desired, with the aim of accelerating the stabilization of the voltage across the terminals of the cell.

For a screen of color sequential type which requires the switching of red, green, blue light sources at each new frame, the switching of light source will be performed at the same time as the counter-electrode switching, therefore while the voltages of the column conductors correspond to a black level actually applied to the cells. Thus, the change of light source does not produce any troublesome luminous spikes. The color switching is not necessarily exactly synchronous with the counter-electrode voltage switching provided that it is done while a black level is still applied to the pixels. FIG. 2 shows a row LUM representing the instants of switching of the sources of red (R) green (G) blue (B) color. The instant of switching represented is the instant t1+Tc but it could be situated slightly before t1+Tc as long as the black level corresponding to the present counter-electrode voltage is applied to the columns at this moment.

FIG. 3 represents a detail of the phase of switching counter-electrode potential. In the example represented, the switching of the light sources is done at the instant t1+Tc which is the instant of the end of addressing of the last row of pixels. The new writing data are applied after this instant. This more detailed figure shows that the duration Tc may be nearly a millisecond whereas the duration t1−t0 may be from 0.1 to 0.5 milliseconds.

The invention is particularly beneficial for screens of very small dimension (with sides of a few millimeters to a few centimeters) and notably for screens serving as transmissive optical modulators in image projectors.

It is particularly beneficial for normally white screens or optical modulators since the phase of switching the counter-electrode potential corresponds, which establishes a black level, corresponds to a precharge to Vmax−Vmin of the capacitors constituted by the cells and not to a discharge to 0 volts of these capacitors. The precharged capacitors make it possible for the desired gray levels to be applied more easily thereafter.

In the preceding detailed description, it was considered that the individual electrodes Ep were able to receive voltages between 0 and 6 volts and that the voltage of the counter-electrode CE varied likewise between 0 and 6 volts. It is necessary to consider that these voltage values are related to the requirement to produce across the terminals of the liquid crystal an electric field sufficient to obtain a good white level (in the case of normally black screens) or a good black level (in the case of normally white screens).

When the display is embodied on an integrated circuit substrate, these voltages are acceptable for certain integrated-circuit fabrication technologies. But other contemporary technologies do not make it possible to use these voltage levels, in particular technologies allowing very dense integration for screens of very small dimension and of good resolution.

Consequently it may happen that the span of voltages applied to the transistors of the integrated circuit must be limited (typically to 3 volts). For simplicity, it will be considered here that the maximum voltage that can be supported by the transistors is the supply voltage Vcc of the integrated circuit, this voltage being applied to a terminal of the semiconductor substrate and the substrate itself being able to define the 0 potential reference for the display as a whole.

In this case, the voltage applied to the individual electrodes Ep of the pixels oscillates between 0 volts (reference voltage of the substrate) and the maximum value Vcc (typically 3 volts); but these voltage values cannot in practice be used to establish the voltage on the counter-electrode. Indeed, a discrepancy of 3 volts between individual pixel electrode and counter-electrode is in general not sufficient to produce good black quality (in the case of a normally white screen) or good white quality (in the case of a normally black screen).

According to a significant aspect of the invention, provision is made for the voltage applied to the counter-electrode to oscillate between two values Vmin and Vmax which are produced by a voltage source outside the substrate and which are not limited to the span of voltages from 0 volts to Vcc.

The outside voltage source is controlled by the integrated circuit in synchronism with the control of the pixel electrodes.

The choice of the voltages Vmin and Vmax is then dictated by a compromise between sufficient quality of “white” and sufficient quality of “black”.

If this is applied by way of preferred example to a normally white screen, it is considered that a quality white is obtained when the voltage between the pixel electrode and the counter-electrode is in absolute value less than a threshold voltage which is a positive value Vth. Conversely, to have a quality black it is necessary for the voltage between the pixel electrode and the counter-electrode to be greater in absolute value than a voltage VT.

For an even frame for example, a white pixel will correspond to an electrode voltage Ep of 0 volts and a black pixel will correspond to an electrode voltage Ep of Vcc. For the following frame it will be the converse. It is therefore necessary on the one hand that the counter-electrode in the first frame be at a level Vmin which is higher −Vth, else the white would not be good, but lower than (Vcc−VT), else the black would not be good. And in the second frame it is necessary that Vmax be at a level lower than Vcc+Vth, else the white would not be good and at a level higher than VT, else the black would not be good.

−Vth<Vmin<Vcc−VT

VT<Vmax<Vcc+Vth

This assumes that Vcc+Vth is greater than or equal to VT

Typically, we have for example Vth=1.5 to 1.6 volts. If Vcc is equal to 3 volts, this implies that the black is satisfactory for a voltage VT of 4.5 volts across the terminals of the liquid crystal and it has been verified that this is possible.

This value VT=4.5 volts is not necessarily an optimal value for having excellent contrast; a markedly higher voltage VT would indeed be necessary. But this value is considered sufficient for certain applications, even if it is then necessary to enhance the contrast by other means such as the use of contrast improving films on the display.

In practice, therefore, voltages Vmin and Vmax are chosen which are respectively equal to −Vth and Vcc+Vth (−1.5 volt and +4.5 volt) or very slightly higher than −Vth and very slightly lower than Vcc+Vth. And these voltages are applied to the counter-electrode with the aid of a voltage source outside the semiconductor substrate of the display.

The use of a voltage source outside the semiconductor substrate, capable of providing the counter-electrode with switching voltages Vmin and Vmax whose discrepancy is greater than the supply voltage Vcc of the integrated circuits (including the pixel electrodes) is possible when the writing comprises a phase of erasure between two frames, carried out as explained with reference to FIGS. 2 and 3 or otherwise. It is also possible when there is no erasure phase. Such an outside source is indeed useful as soon as the method for writing the display involves a periodic switching of the counter-electrode potential if the discrepancy between the potentials of the counter-electrode is greater than the maximum voltage supported by the elements of the integrated circuit which controls the pixels.

To improve image erasure between two frames, at the moment when the pixel electrodes are brought to a black level potential and when the potential of the counter-electrode is switched, provision is preferably made for the switching of the counter-electrode to comprise a phase of acceleration of erasure; during this phase, the counter-electrode potential is brought momentarily to a value greater than Vmax or respectively less than Vmin before resuming the normal setpoint value Vmax or Vmin that it must preserve during the entire frame. This increase of potential in absolute value is desirable in particular because of the fact that the potentials Vmin and Vmax are at the limit of what makes it possible to obtain good black quality and it is better to increase them temporarily in absolute value for good erasure.

This erasure acceleration phase occurs at the moment when the pixel electrodes are all brought to a potential corresponding to the black level (0 volts for one frame, Vcc for the next frame).

The timechart of FIG. 4 represents a phase of erasure between two frames, comprising a switching of counter-electrode potential from the potential Vmin to the potential Vmax, and a simultaneous switching of the black level potential applied to all the pixels (for example by the process explained with reference to FIGS. 2 and 3, with overvoltages at a level VMAX (for example +5.5 volts or +6 volts) above Vmax (+4.5 volts) and a level VMIN (for example −2.5 or −3 volts) below Vmin.

The erasure phase actually begins at an instant t1 (but it could begin before, at the instant t0 if operating according to the timechart of FIG. 2), and it actually terminates at an instant t0+Tc (but the following frame will start only after the instant t1+Tc if operating according to the timechart of FIG. 2).

There is preferably in this order:

the application of a black level potential (BL) to all the individual pixel electrodes; here the case of a normally white screen is assumed, but it would be possible to transpose to a normally black screen; the black potential is 0 volts and the counter-electrode potential is Vmax;

the application of a brief overvoltage at VMAX>Vmax to the counter-electrode so as to orient the liquid crystal molecules more rapidly toward their black level state; VMAX is preferably +6 volts if Vmax=4.5 volts;

the switching of the counter-electrode potential to the setpoint level Vmin that it must have in the following frame, but with an overvoltage at VMIN<Vmin; VMIN=−3 volts if Vmin=−1.5 volts;

simultaneously with the switching of counter-electrode potential: the switching of all the individual electrodes to the new black level potential BL_Inv (here Vcc); this new potential is required by the switching of counter-electrode potential to Vmin.

the return of the counter-electrode potential to its setpoint value Vmin for the second frame, until the end of the latter.

The writing of the second frame can begin row by row after the return to the value Vmin; in the case where the row conductors of the matrix are successively rendered conducting, writing begins only after the instant t1+Tc defined in regard to FIG. 2.

FIG. 5 represents an analogous timechart, for the following frame in which the potential of the counter-electrode passes from Vmin to Vmax, passing through a first overvoltage at VMIN and a second overvoltage at VMAX.

Preferably, provision is made for the image to be refreshed at least once in the course of a frame, that is to say the column potential corresponding to each image point is written again, row by row, in each pixel.

The reason for this is the fact that the voltage across the terminals of the liquid crystal tends to change over the duration of the frame: a voltage is applied at an instant of writing, but the pixel is thereafter isolated and ceases to be maintained at this voltage; but, the voltage applied tends to modify the orientation of the molecules of the crystal (as a function of the desired gray level) and this change of physical orientation itself induces a change of dielectric constant, therefore of capacitance, of the liquid crystal. As the electric charge received at the moment of writing does not vary once the pixel is isolated, it is the voltage (V=Q/C) which will vary in tandem with the change of orientation of the molecules. Rather than compensating for this variation by providing a wide storage capacitor associated with the pixel, it is preferred to rewrite the image one or more times in the course of the frame. A storage capacitor would be particularly detrimental for displays of transmissive type since it would appreciably reduce the opening of the pixel. A rewriting of the image consumes more energy, but as the integrated circuit works at a low supply voltage Vcc (3 volts), the consumption is not exaggerated.

Provision may for example be made for one or two refreshes in the course of the frame. The limit of the number of possible refreshes depends on the ratio of the duration of the frame to the time required for the writing of all the rows of the matrix.

1. A method for writing an image in a liquid-crystal display, the display comprising a matrix of rows and columns of pixels, each pixel comprising a liquid crystal between a pixel electrode and a counter-electrode common to all pixels, with a control transistor linking the pixel electrode to a respective column conductor common to all the pixels of one and the same column, the respective column conductor receiving an analog signal defining a gray level to be applied to the pixel, the control transistors of the pixels of one and the same row being controlled by a respective row conductor, which method comprises a writing phase for each frame of alternating odd frames and even frames, said writing phase comprising switching a potential applied to the counter-electrode between a low value during the odd frames and a high value during the even frames, successively addressing the various rows and simultaneously applying voltage levels to the column conductors, and wherein the writing phase is followed, before the end of a frame, by a switching phase in which the transistors of the various rows are successively turned on row by row for durations which overlap mutually in such a way that all transistors of all rows are simultaneously on at a given moment of this switching phase, and the potential of the counter-electrode is switched at this moment from said low value to said high value or the reverse.

2. The writing method as claimed in claim 1, wherein a duration of turning on of the transistors is the same for all the rows, and longer than the time which separates a start of the turning on of the transistors of the first row and a start of the turning on of the transistors of the last row.

3. The writing method as claimed in claim 2, wherein the rows are successively addressed during the switching phase at a rate which is faster than a rate of successively addressing the rows during the writing phase.

4. The writing method as claimed in claim 1, wherein a voltage level corresponding to a black level for a given frame is applied to the column conductors during the switching phase, and this level is switched to a level corresponding to a black level of an immediately following frame, at the moment of the switching of the counter-electrode potential.

5. The writing method as claimed in claim 1, wherein the display is a normally white display whose transparency is a maximum for a zero voltage between pixel electrode and counter-electrode.

6. The writing method as claimed in claim 1, wherein the display is embodied on a semiconductor substrate supplied by a supply voltage of value Vcc referenced with respect to an earth, and the voltages applied to the counter-electrode are provided by a voltage source outside the substrate, able to provide two potentials with a discrepancy between these two potentials greater than the value Vcc.

7. The writing method as claimed in claim 6, wherein if Vth is the threshold voltage below which a pixel remains white, the outside voltage source provides a voltage Vmin=−Vth during one frame out of two and Vmax=Vcc+Vth during the other frames.

8. The writing method as claimed in claim 6, wherein the phase of switching the counter-electrode potential comprises the following steps: to begin with, the counter-electrode voltage is increased in absolute value before it is switched and, during the switching, it is firstly given a higher value in absolute value than the setpoint value that it will have during the writing of the following frame, and then the counter-electrode voltage is brought back to this setpoint value.

9. The method as claimed in claim 1, wherein the writing phase for a frame comprises a first writing of all the rows at the start of a frame and then at least one refresh writing in the course of the frame.
